(19) United States
(12) Patent Application Publication
(10) Pub. No.: US 2009/0200774 A1
(43) Pub. Date: Aug. 13, 2009

(54) LOW RISK DEPLOYMENT SIDE AIRBAG SYSTEM

(75) Inventors: Jong Seop Nam, Commerce Township, MI (US); Seung-Jae Song, Novi, MI (US)

Correspondence Address: GIFFORD, KRASS, SPRINKLE,ANDERSON & CITKOWSKI, P.C, PO BOX 7021, TROY, MI, 48007-7021, US

(73) Assignee: CIS Tech, LLC, Novi, MI (US)

(21) Appl. No.: 12/102,422

(22) Filed: Apr. 14, 2008

Related U.S. Application Data
(60) Provisional application No. 61/028,271, filed on Feb. 13, 2008.
(60) Provisional application No. 61/030,700, filed on Feb. 22, 2008.
(60) Provisional application No. 61/038,268, filed on Mar. 20, 2008.

(51) Int. Cl. B60R 21/16

(52) U.S. Cl. 280/730.2

(57) ABSTRACT

A side head airbag is installed in a headrest of a vehicle seat and deploys laterally forward with respect to the vehicle toward a gap located between an occupant's head and a side window for the protection of the occupant's head during a serious side impact crash. The side head airbag has a tether constructed in such a way as to minimize the inefficient voids that are commonly seen from side curtain airbags. The side head airbag may have a two chamber construction to improve the energy absorption mechanism from an elastic loading/unloading to a plastic loading/unloading along with a roll-over protection. Another restraint may be installed, separately from the head airbag, in a seatback or in a side structure to protect an occupant's thorax and/or pelvis during a serious side impact crash.

### REFERENCE TO RELATED APPLICATIONS

This application claims priority from U.S. Provisional Patent Application Ser. Nos. 61/028,271, filed Feb. 13, 2008; 61/030,700, filed Feb. 22, 2008; and 61/038,268, f. Mar. 20, 2008, the entire content of all of which are incorporated herein by reference.

### FIELD OF THE INVENTION

This invention relates to a side airbag system for use with a motor vehicle, wherein a side head airbag is installed in a headrest and a side thorax/pelvis airbag is installed in a seatback in such a way as to minimize the risk of injuries caused by airbag inflation to an out-of-position occupant while improving in-position occupant protection during serious side impact crashes.

### BACKGROUND OF THE INVENTION

Side impact crashes are responsible for about one third of deaths caused by all types of crashes. A thorax/pelvis airbag installed in a seatback is used to protect an occupant's torso (thorax and/or pelvis) during a serious side impact crash. Even though lab tests show that the torso is typically a crucial area that receives serious injuries, the head is also responsible for a significant percentage of deaths caused by side impact in real world crashes.

Two types of head airbags are developed and being used in today's vehicles. One extends upward from the thorax airbag toward the gap between the head and a side window. This airbag is called a side head/thorax airbag. The other is installed alone a roof rail right above the side windows and deploys downward toward the gap between the head and side windows. This airbag is called a side curtain airbag and is currently much more popular than the head/thorax airbag.

The advantage of the side head/thorax airbag is cost effectiveness, as it can protect the head and the thorax with one airbag. The disadvantage of the side head/thorax airbag is the risk of injuries caused by the airbag inflation to out of position occupants, especially for small occupants such as children. The other disadvantage could be the interference with the occupant's arm and the shoulder belt during the airbag deployment.

The advantage of the side curtain airbag is the wide coverage of the protection area, typically ranging from the A-pillar to the C-pillar along the side windows. Therefore, it can protect the head wherever the occupant is positioned at the time of head impact. Due to the extensive coverage, which requires a large volume airbag, the side curtain airbag is partitioned into several small chambers to effectively restrain the head when it hits a small portion of the large surface area of the airbag. All the small chambers are in fluid communication with wide openings to each other in order to quickly receive the gas from an inflator. The chambers, however, create voids outside the airbag between the chambers after full inflation and reduce the effectiveness of head protection, especially when the head hits the void area. The large amount of total airbag volume also reduces the effectiveness of the head protection even if the head pushes against the center of one of the chambers, because the gas in the chamber easily escapes to the other chambers.

The objective of the present invention is therefore to design a side airbag system that can effectively protect the occupant while reducing the risk of injuries caused by airbag inflation to out of position occupants.

### SUMMARY OF THE INVENTION

A side airbag system according to the present invention is designed for use in an automotive vehicle having a seat for supporting an occupant and a side structure adjacent the seat. The seat includes a seatback and a headrest with a support structure therein. The side structure includes a door trim panel and a side window. The side airbag system includes an airbag module with an inflator, a housing, and an airbag cushion. The airbag module is installed within the headrest and mounted to the support structure in the headrest. The housing has an open end directed in a first direction, the first direction being disposed between perpendicular to the side structure and forward with respect to the vehicle when viewed in a top view, and between generally horizontal and vertical with respect to the vehicle when viewed in a rear view. The airbag cushion has a first face which is adjacent the side structure when the airbag cushion is inflated and an opposed second face which is directed toward the occupant when the airbag cushion is inflated. The first and second faces each have a perimeter and a central region, the perimeters of the first and second faces being joined to form the airbag cushion. The airbag cushion also has a tether extending between the central regions of the first and second faces. The tether has a tether length in the range of 50 to 150 mm and restrains the first and second faces such that substantially the entirety of the central regions are spaced apart by at least a distance equal to the tether length when the airbag cushion is inflated. The airbag cushion deploys laterally forward with respect to the vehicle toward a gap located between the occupant's head and the side structure for the protection of the occupant's head during a side impact crash.

The side airbag system may also include a side thorax/pelvis airbag module installed in a seatback which deploys laterally toward a gap between the thorax/pelvis and a side structure such as a door trim to protect the occupant's thorax/pelvis.

The inflator for the head airbag may be a cylindrical shaped inflator having an axis along its length, the inflator being disposed in the headrest such that the axis extend generally vertically.

The airbag module may be configured and installed such that the first direction is disposed at a first angle with respect to a line perpendicular to the side structure when viewed in a top view, the first angle being in the range of 30 to 80 degrees forward of the perpendicular line. The first direction may also be disposed at a second angle with respect to a horizontal line when viewed from the rear, the second angle being in the range of 10 degrees below the horizontal line to 30 degrees above the horizontal line.

In some embodiments, the central regions of the first and second faces of the airbag cushion are separated by a distance no greater than approximately 200 mm when the airbag cushion is inflated.

The airbag cushion may be large enough to cover the side window from top to bottom when the airbag cushion is inflated. The airbag cushion may have a vent defined therein such that gas from the inflated airbag cushion is vented from the airbag cushion when the occupant's head impacts the airbag cushion and the impact energy is absorbed through a plastic loading.

In a further embodiment of the present invention, a side airbag system includes an airbag module having an inflator, a housing, and an airbag cushion, the airbag module being installed within the headrest and mounted to the support structure in the headrest. The housing has an open end directed in a first direction, the first direction being disposed between perpendicular to the side structure and forward with respect to the vehicle when viewed in a top view and between generally horizontal and vertical with respect to the vehicle when viewed in a rear view. The airbag cushion has at least a first chamber and a second chamber, the first chamber being attached to the inflator and the second chamber being attached to the first chamber. A partitioning membrane is disposed between the two chambers. The partitioning membrane has a small opening defined therethrough for gas to flow from the first chamber into the second chamber. The airbag cushion deploys laterally forward with respect to the vehicle toward a gap located between the occupant's head and the side structure for the protection of the occupant's head during a side impact crash. In some embodiments, the size of the small opening in the membrane is in the range of 1 to 15 square centimeters.

In some versions of this further embodiment, the airbag cushion has a first face which is adjacent the side structure when the airbag cushion is inflated and an opposed second face which is directed toward the occupant when the airbag cushion is inflated, the first and second faces each having a perimeter and a central region. The perimeters of the first and second faces are joined to form the airbag cushion. The airbag cushion has a tether extending between the central regions of the first and second faces. The tether has a tether length in the range of 50 to 150 mm and restrains the first and second faces such that substantially the entirety of the central regions are spaced apart by at least a distance equal to the tether length when the airbag cushion is inflated. In some versions, the central regions of the first and second faces of the airbag cushion are separated by a distance no greater than approximately 200 mm when the airbag cushion is inflated.

The side airbag system may include a second airbag module having an inflator, a housing, and an airbag cushion, with the airbag module being installed within the seatback or the side structure. The airbag cushion deploys laterally forward with respect to the vehicle toward a gap located between the occupant thorax and/or pelvis and the side structure for the protection of the occupant's thorax and/or pelvis during a side impact.

The airbag module may be configured and installed such that the first direction is disposed at a first angle with respect to a line perpendicular to the side structure when viewed in a top view, the first angle being in the range of 30 to 80 degrees forward of the perpendicular line. The first direction may also be disposed at a second angle with respect to a horizontal line when viewed from the rear, the second angle being in the range of 10 degrees below the horizontal line to 30 degrees above the horizontal line.

### BRIEF DESCRIPTION OF THE DRAWINGS

Advantages of the present invention will be readily appreciated as the same becomes better understood by reference to the following description when considered in connection with the accompanying drawings, wherein:

FIG. 1 shows a side view of a prior art system in which a side curtain airbag is installed along a roof rail and is deployed downwardly into the gap between the occupant's head and the side windows;

FIG. 2 shows a top view of the prior art system in which the side curtain airbag creates large voids between adjacent chambers;

FIG. 3 shows a side view of an embodiment of the present invention in which a side head airbag module is installed in a headrest and the airbag is deployed laterally forward into the cap between the occupant's head and a side window;

FIG. 4 shows a top view of the embodiment of the present invention in which the airbag has a tether construction and therefore does not create as much of a void;

FIG. 5 shows a rear view of the embodiment of the present invention in which the airbag module is tilted slightly upward; and

FIG. 6 shows another embodiment of the present invention in which the side head airbag has a two-chamber construction and the membrane between the two chambers significantly restricts the flow of gas from the first chamber to the second chamber.

### DETAILED DESCRIPTION OF THE INVENTION

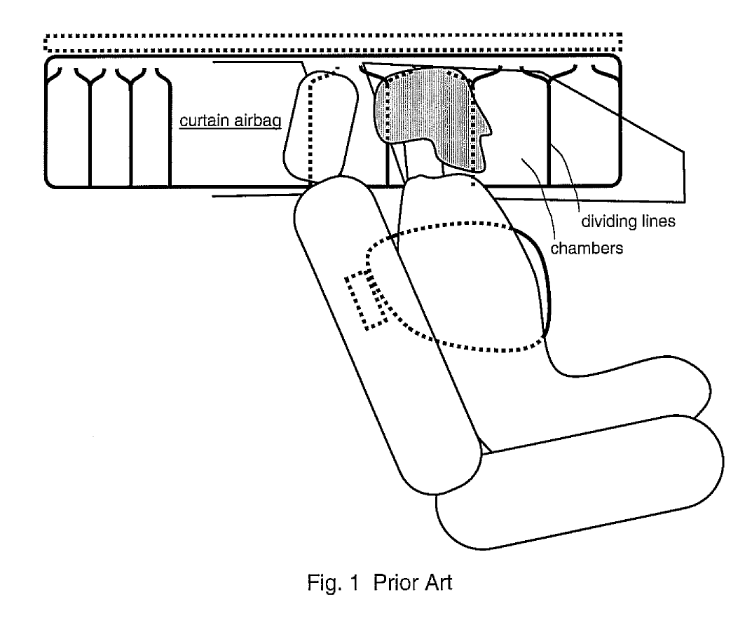

FIG. 1 shows a prior art system including a side curtain airbag that is installed along a roof rail and deploys downwardly into the gap between the occupant's head and the side windows. The airbag covers the whole area starting from close to the A-pillar to the C-pillar. This wide airbag can restrain the occupant's head during a side impact no matter where the occupant is located at the time of the impact.

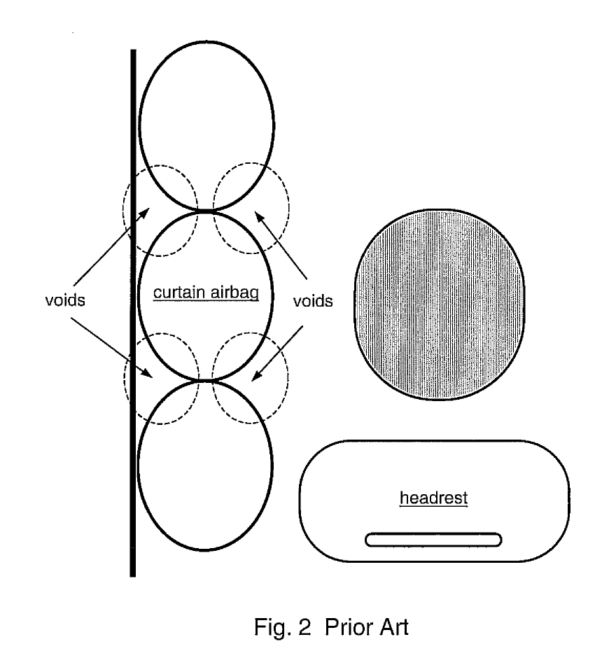

FIG. 2 shows a top view of the side curtain airbag shown in FIG. 1. Due to the multi chamber construction, it creates large voids between chambers, thereby reducing the effectiveness of the head protection especially when the head contacts the void area. The large total airbag volume also reduces the effectiveness of energy absorption of the head impact energy. The curtain airbag is typically constructed without any type of venting mechanism, which creates an elastic loading/unloading condition during the impact. The elastic loading/unloading condition can generate a rebound velocity up to the initial impact velocity and can cause a serious secondary impact. For example, the head impacting a rigid pole at 20 mph can rebound with the same velocity of 20 mph. The head impacted by an intruding door during a moving deformable barrier test with a 15 mph door velocity can rebound with double the velocity of 30 mph.

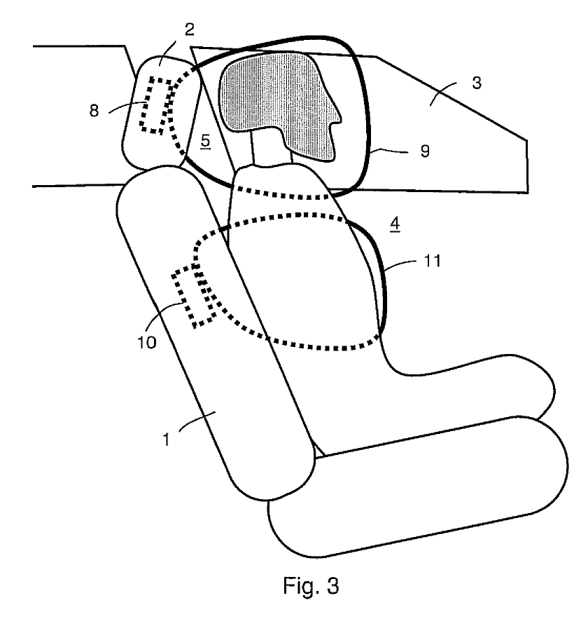

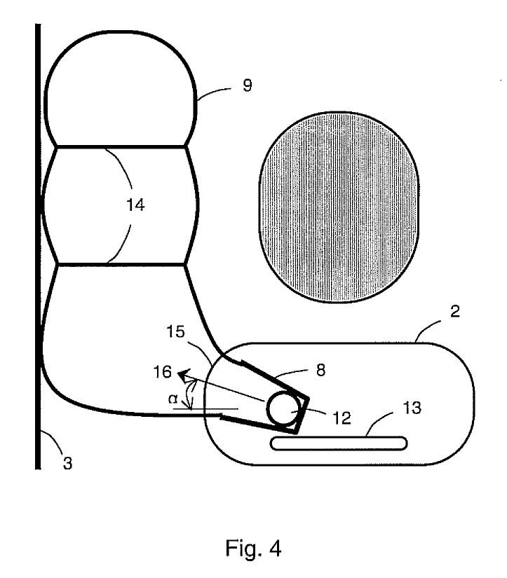

FIG. 3 shows a side view of an embodiment of the present invention, viewed from the front passenger side toward the driver. FIG. 4 shows a top view of the system of FIG. 3. A vehicle has a seat having a seatback 1, a headrest 2, and a side structure such as a door trim 4, a side window 3, and a pillar 5. An occupant with a torso 6 and a head 7 is sitting in the seat. A side head airbag module 8 is installed within the headrest 2 and mounted to any solid structure in the headrest such as a headrest frame 13 as shown in FIG. 4. The airbag module comprises an inflator 12, a housing 8, and an airbag cushion 9. The housing 8 has an opening end through which the airbag cushion deploys. This opening end may be said to be directed in a first direction 16. A housing angle α is shown as the angle between this first direction 16 and perpendicular to the side structure or side window 3 when viewed from above. The housing angle a may be in the range of 0 (zero) to 90 degrees forward of the perpendicular line. Zero degrees means that the first direction is perpendicular to the side structure and 90 degrees means that the first direction is 90 degrees forward of a perpendicular line, which is directly forward with respect to the vehicle.

The airbag cushion 9 preferably has one or more tethers 14 that restrain the airbag cushion such that has an elongated balloon type shape rather than a spherical ball type. The airbag cushion 9 may be said to have a first face which is adjacent the side structure 3 when the airbag cushion is inflated and an opposed second face that is directed toward the occupant when the airbag cushion is inflated. The first and second faces may both be said to have a perimeter and a central region with the perimeters joined together to form the cushion. The central regions are spaced apart by a distance to provide cushioning during an impact. If this distance is too small, the airbag cushion provides insufficient cushioning. If the distance is too large, the cushion requires a large amount of gas to inflate, thereby requiring higher inflation pressures and rates. With higher inflation levels, the risk to an out of position occupant is increased. If such an out of position occupant has a body part resting adjacent the airbag housing when inflation occurs, a high inflation rate may injure the occupant.

The use of one or more tethers 14 in the present invention allow the distance between the faces of the cushion to be controlled to provide a good balance between thickness for cushioning and inflation volume. The tethers 14 extend between the central regions of the airbag cushion faces. The tethers 14 preferably have a length in the range of 50 to 150 mm such that the distance between the entirety of the central regions of the first and second faces is at least equal to the tether length. Areas away from the tether attachment may have greater thickness, but it is preferred that the thickness in these areas not be greater than 200 mm.

The airbag cushion 9 is initially located within the airbag housing 8 and is pressurized by the gas supplied by the inflator 12. As the cushion inflates, it tears a portion of the headrest at the outer side 15 and makes an opening outlet. The airbag cushion then deploys laterally through the opening and forward with respect to the vehicle toward the gap located between the head 7 and the side structure, typically a side window 3. The inflated airbag cushion protects the occupant's head 7 when it is struck by a striking vehicle or a rigid pole during a serious side impact crash. It can also help keep the head from being ejected through the window during a roll over event.

A side thorax airbag module 10 may be installed within the seatback 1. The airbag module comprises an inflator, a housing, and an airbag cushion. The airbag module is mounted to a solid structure within the seatback such as a seat frame. The airbag cushion deploys laterally forward with respect to the vehicle toward the gap located between the thorax/pelvis and the side structure, typically a door trim 4. The inflated airbag cushion protects the occupant's thorax during a serious side impact crash. The thorax airbag cushion shown in FIG. 3 can be extended downward to cover the pelvis as well. This extended airbag is called a thorax/pelvis airbag that protects the thorax and the pelvis during the side impact crash.

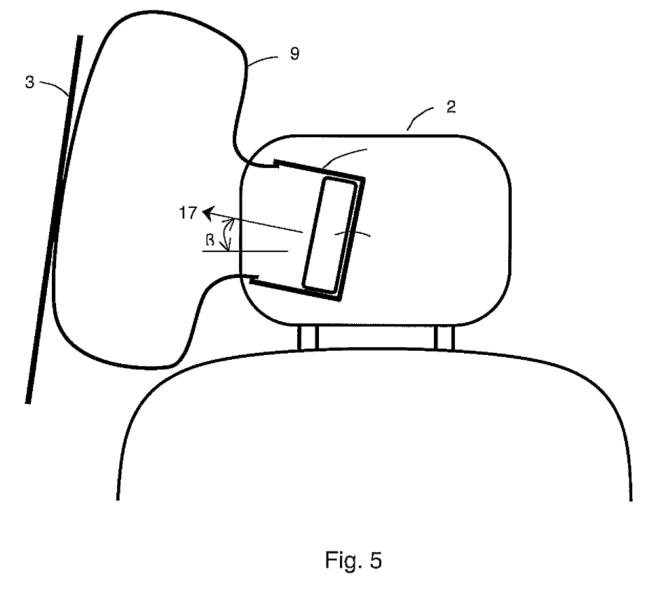

FIG. 5 shows a rear view of the embodiment of the present invention shown in FIGS. 3 and 4. The airbag housing 8 is preferably installed such that it is tilted upward in order to deploy the airbag cushion in a direction 17. This is the same as first direction 16, but is being viewed from the rear. The first direction 17 may be disposed between generally horizontal and vertical when viewed from the rear. An angle β may be defined with respect to horizontal. In some embodiments, the first direction 17 is disposed at an angle β in the range of 0 (zero) degrees to 90 degrees (vertical) above horizontal. In other embodiments, the first direction 17 is disposed at an angle β between 10 degrees below horizontal and 30 degrees above horizontal. This tilted design can improve the airbag kinematics during deployment as it can help avoid interference with a shoulder belt. The tilted angle can also make the airbag cushion interact better with the side window, which is also typically angled. As also shown in FIG. 5, the airbag inflator 12 is preferably of a cylindrical type. It may be said to have an axis, and the inflator is installed in the headrest such that this axis extends generally vertical, as shown. This improves packaging and provides other benefits.

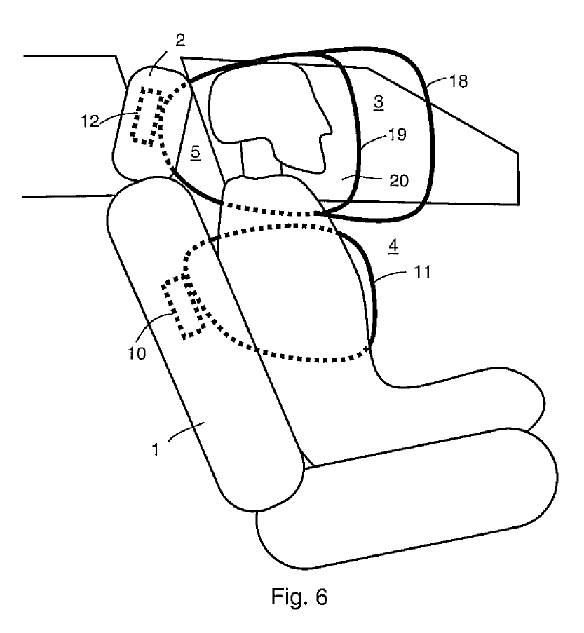

FIG. 6 shows another embodiment of the present invention in which the side head airbag cushion is composed of two chambers. The first chamber 20 is attached to the airbag housing and/or inflator 12 and receives gas from the inflator. The second chamber 18 is attached to the forward end of the first chamber with respect to the vehicle direction. A partitioning membrane 19 separates the two chambers. The partitioning membrane 19 has a small size opening such as a hole(s) to significantly restrict the flow of gas from the first chamber to the second chamber so that the first chamber gets inflated fast for the head protection from the side impact and the second chamber gets inflated thereafter. The size of the opening between the two chambers is in the range of 1 cm² to 20 cm², or more preferably in the range of 1 cm² to 15 cm². The two chamber construction can improve the head protection during a roll over event by covering a wider area of the side window while maintaining the gas pressure inside the airbag cushion for an elongated time. Another benefit from the two chamber construction is the plastic loading/unloading condition for the occupant's head during the impact to the first airbag chamber 20. This is due to gas flowing from the first chamber 20 to the second chamber 18 as the head pushes against the first chamber. The plastic loading/unloading condition does not increase the rebound velocity as much as the elastic loading/unloading condition. This plastic loading condition may also be provided with the embodiment of the present invention shown in FIGS. 3-5, for example by providing a vent that controls the release of gas. Also, the embodiment of the invention shown in FIG. 6 may make use of any of the features described previously, such as tethers to control the shape of one or more chambers.

As will be clear to those of skill in the art, the herein-described embodiments of the present invention may be altered in various ways without departing from the scope or teaching of the present invention. It is the following claims, including all equivalents, that define the scope of the present invention.

1. A side airbag system for an automotive vehicle having a seat for supporting an occupant and a side structure adjacent the seat, the seat including a seatback and a headrest with a support structure therein, the side structure including a door trim panel and a side window, the side airbag system comprising:
an airbag module having an inflator, a housing, and an airbag cushion, the airbag module being installed within the headrest and mounted to the support structure in the headrest;
the housing having an open end directed in a first direction, the first direction being disposed between perpendicular to the side structure and forward with respect to the vehicle when viewed in a top view, the first direction further being disposed between generally horizontal and vertical with respect to the vehicle when viewed in a rear view;
the airbag cushion having a first face which is adjacent the side structure when the airbag cushion is inflated and an opposed second face which is directed toward the occupant when the airbag cushion is inflated, the first and second faces each having a perimeter and a central region, the perimeters of the first and second faces being joined to form the airbag cushion, the airbag cushion further having a tether extending between the central regions of the first and second faces, the tether having a tether length in the range of 50 to 150 mm and restraining the first and second faces such that substantially the entirety of the central regions are spaced apart by at least a distance equal to the tether length when the airbag cushion is inflated; and
the airbag cushion deploying laterally forward with respect to the vehicle toward a gap located between the occupant's head and the side structure for the protection of the occupant's head during a side impact crash.

2. A side airbag system according to claim 1, wherein the inflator comprises a cylindrical shaped inflator having an axis along its length, the inflator being disposed in the headrest such that the axis extends generally vertically.

3. A side airbag system according to claim 1, wherein the first direction is disposed at a first angle with respect to a line perpendicular to the side structure when viewed in a top view, the first angle being in the range of 30 to 80 degrees forward of the perpendicular line, the first direction further being disposed at a second angle with respect to a horizontal line when viewed from the rear, the second angle being in the range of 10 degrees below the horizontal line to 30 degrees above the horizontal line.

4. A side airbag system according to claim 1, wherein the central regions of the first and second faces of the airbag cushion are separated by a distance no greater than approximately 200 mm when the airbag cushion is inflated.

5. A side airbag system according to claim 1, wherein the airbag cushion is large enough to cover the side window from top to bottom when the airbag cushion is inflated.

6. A side airbag system according to claim 1, further comprising:
a second airbag module having an inflator, a housing, and an airbag cushion, the airbag module being installed within the seatback or the side structure, the airbag cushion deploying laterally forward with respect to the vehicle toward a gap located between the occupant thorax and/or pelvis and the side structure for the protection of the occupant's thorax and/or pelvis during a side impact.

7. A side airbag system according to claim 1, wherein the airbag cushion has a vent defined therein such that gas from the inflated airbag cushion is vented from the airbag cushion when the occupant's head impacts the airbag cushion and the impact energy is absorbed through a plastic loading.

8. A side airbag system for an automotive vehicle having a seat for supporting an occupant and a side structure adjacent the seat, the seat including a seatback and a headrest with a support structure therein, the side structure including a door trim panel and a side window, the side airbag system comprising:
an airbag module having an inflator, a housing, and an airbag cushion, the airbag module being installed within the headrest and mounted to the support structure in the headrest;
the housing having an open end directed in a first direction, the first direction being disposed between perpendicular to the side structure and forward with respect to the vehicle when viewed in a top view, the first direction further being disposed between generally horizontal and vertical with respect to the vehicle when viewed in a rear view;
the airbag cushion having at least a first chamber and a second chamber, the first chamber being attached to the housing and the second chamber being attached to the first chamber,
a partitioning membrane disposed between the two chambers, the partitioning membrane having a small opening defined therethrough for gas to flow from the first chamber into the second chamber; and
the airbag cushion deploying laterally forward with respect to the vehicle toward a gap located between the occupant's head and the side structure for the protection of the occupant's head during a side impact crash.

9. A side airbag system according to claim 8, wherein the airbag cushion has a first face which is adjacent the side structure when the airbag cushion is inflated and an opposed second face which is directed toward the occupant when the airbag cushion is inflated, the first and second faces each having a perimeter and a central region, the perimeters of the first and second faces being joined to form the airbag cushion, the airbag cushion further having a tether extending between the central regions of the first and second faces.

10. A side airbag system according to claim 9, wherein the tether has a tether length in the range of 50 to 150 mm and restrains the first and second faces such that substantially the entirety of the central regions are spaced apart by at least a distance equal to the tether length when the airbag cushion is inflated.

11. A side airbag system according to claim 10, wherein the central regions of the first and second faces of the airbag cushion are separated by a distance no greater than approximately 200 mm when the airbag cushion is inflated.

12. A side airbag system according to claim 8, further comprising:
a second airbag module having an inflator, a housing, and an airbag cushion, the airbag module being installed within the seatback or the side structure, the airbag cushion deploying laterally forward with respect to the vehicle toward a gap located between the occupant thorax and/or pelvis and the side structure for the protection of the occupant's thorax and/or pelvis during a side impact.

13. A side airbag system according to claim 8, wherein the size of the small opening in the membrane is in the range of 1 to 15 square centimeters.

14. A side airbag system according to claim 8, wherein the first direction is disposed at a first angle with respect to a line perpendicular to the side structure when viewed in a top view, the first angle being in the range of 30 to 80 degrees forward of the perpendicular line, the first direction further being disposed at a second angle with respect to a horizontal line when viewed from the rear, the second angle being in the range of 10 degrees below the horizontal line to 30 degrees above the horizontal line.
